(19) United States
(12) Patent Application Publication
(10) Pub. No.: US 2014/0085365 A1
(43) Pub. Date: Mar. 27, 2014

(54) PRINTING APPARATUS AND PRINTING METHOD

(71) Applicant: Seiko Epson Corporation, Tokyo (JP)

(72) Inventors: Nagatoshi Kasahara, Matsumoto (JP); Tomohiro Sayama, Matsumoto (JP); Hironori Sato, Matsumoto (JP); Masako Fukuda, Shiojiri (JP); Hiroshi Mukai, Shiojiri (JP); Toshihiro Shinbara, Matsumoto (JP)

(73) Assignee: Seiko Epson Corporation, Tokyo (JP)

(21) Appl. No.: 14/030,184

(22) Filed: Sep. 18, 2013

(30) Foreign Application Priority Data
Sep. 25, 2012 (JP) 2012-211419

(51) Int. Cl. B41J 2/045

(52) U.S. Cl. CPC B41J 2/04588
USPC 347/10

(57) ABSTRACT

A printing apparatus, has a head having a plurality of nozzles for discharging an ink containing thermoplastic resin particles and having a viscosity at 50° C. of 2.1 mPa·s or more to a non-ink-absorbing medium and a drive element provided in each of the nozzles, a heating portion which heats the medium, and a control portion which drives the drive elements by applying a drive waveform to discharge ink droplets from the nozzles corresponding to the drive elements, in which a first ink droplet is discharged from the nozzle by the application of the drive waveform to the drive element, and the discharge speed of an ink droplet whose discharge speed is lower of a second ink droplet and a third ink droplet discharged accompanying the first ink droplet is 4.0 m/s or more.

### BACKGROUND

1. Technical Field

The present invention relates to a printing apparatus and a printing method.

2. Related Art

As a printing apparatus, an ink jet printer (hereinafter referred to as a printer) having a head which discharges ink droplets from nozzles is known. In recent years, the printer has been demanded to print images on various media, such as paper, cloth, and plastic film. For example, in order to print images on non-absorbing media which do not absorb ink, such as plastic film, a printer employing an ink containing thermoplastic resin particles has been proposed (e.g., JP-A-2010-221670). The use of the ink containing thermoplastic resin particles allows the formation of a firm resin film on the media after drying the ink, so that the scratch resistance of printed matter can be secured.

The ink droplets impacting on the non-ink-absorbing medium are likely to flow. Therefore, a printer employing a non-ink-absorbing medium is required to perform printing while heating the medium in order to accelerate drying of the ink droplets impacting on the medium to suppress the flow of the ink droplets. On the other hand, when the ink droplets are discharged from nozzles, minute ink droplets are sometimes generated accompanying a main ink droplet with the main ink droplet. When the minute ink droplets generated accompanying the main ink droplet lose the speed at some midpoint to rise up in the form of mist, the ink mist sometimes adhere to a nozzle opening surface of a head. As described above, in the printer employing the non-ink-absorbing medium, the temperature of the nozzle opening surface of the head becomes high under the influence of the heat for heating the medium. Thus, when the ink mist adheres to the nozzle opening surface of the head, the ink dries to stick to the nozzle opening surface. As a result, the ink is deposited on the nozzle opening surface of the head, so that the discharge of the ink droplets from nozzles is inhibited due to the deposited ink.

### SUMMARY

An advantage of some aspects of the invention to provide a printing apparatus and a printing method which reduce the ink adhesion amount to a nozzle opening surface of a head.

According to an aspect of the invention, a printing apparatus has: a head having a plurality of nozzles for discharging an ink containing thermoplastic resin particles and having a viscosity at 50° C. of 2.1 mPa·s or more to a non-ink-absorbing medium and a drive element provided in each of the nozzles; a heating portion which heats the medium; and a control portion which drives the drive element by applying a drive waveform to discharge ink droplets from the nozzles corresponding to the drive elements; in which a first ink droplet is discharged from the nozzle by the application of the drive waveform to the drive element, and the discharge speed of an ink droplet whose discharge speed is lower of a second ink droplet and a third ink droplet discharged accompanying the first ink droplet is 4.0 m/s or more.

Other features of the invention will become apparent from the description of this specification and the accompanying drawings.

### BRIEF DESCRIPTION OF THE DRAWINGS

The invention will be described with reference to the accompanying drawings, wherein like numbers reference like elements.

FIG. 1 is a block diagram illustrating the entire configuration of a printing system.

FIG. 2A is a schematic cross sectional view of a printer.

FIG. 2B is a schematic upper surface view of the printer.

FIG. 3A is a schematic cross sectional view illustrating the structure of a head.

FIG. 3B is a view illustrating a drive waveform for discharging ink droplets from nozzles.

FIG. 4 is a view illustrating the ink droplets to be discharged from the nozzles.

FIG. 5A is a table showing a difference in the discharge speed among ink droplets in Example of the invention and ink droplets of Comparative Examples and the results of evaluating the formation of mist of a third ink droplet.

FIG. 5B is a table showing the generation number of non-discharging nozzles in Example of the invention and Comparative Examples.

FIG. 6A to FIG. 6C are graphs showing changes in the speed of the first to third ink droplets in Example of the invention and Comparative Examples.

FIG. 7A is a flow chart showing a printing method.

FIG. 7B is a view illustrating wiping treatment.

### DESCRIPTION OF EXEMPLARY EMBODIMENTS

Embodiments of the invention are described with reference to the description of this specification and the accompanying drawings.

A printing apparatus has a head having a plurality of nozzles for discharging an ink containing thermoplastic resin particles and having a viscosity at 50° C. of 2.1 mPa·s or more to a non-ink-absorbing medium and a drive element provided in each of the nozzles, a heating portion which heats the medium, and a control portion which drives the drive element by applying a drive waveform to discharge ink droplets from the nozzles corresponding to the drive elements; in which a first ink droplet is discharged from the nozzle by the application of the drive waveform to the drive element, and the discharge speed of an ink droplet whose discharge speed is lower of a second ink droplet and a third ink droplet discharged accompanying the first ink droplet is 4.0 m/s or more.

According to such a printing apparatus, the generation of ink mist can be suppressed and the ink adhesion amount to a nozzle opening surface of the head can be reduced.

The printing apparatus is a printing apparatus in which the discharge speed of the first ink droplet is 7.0 m/s or lower.

According to such a printing apparatus, a reduction in the discharge speed of the third ink droplet can be suppressed and the ink adhesion amount to the nozzle opening surface of the head can be reduced.

The printing apparatus is a printing apparatus having a wiper member which abuts on the nozzle opening surface of the head in which opening portions of the nozzles are provided, in which the control portion relatively displaces the nozzle opening surface and the wiper member in the state where the wiper member is made to abut on the nozzle opening surface to thereby wipe off foreign substances adhering to the nozzle opening surface. According to such a printing apparatus, ink deposited on the nozzle opening surface can be wiped off, so that the inhibition of the discharge of the ink droplets from the nozzles due to the deposited ink can be suppressed.

A printing method employing (1) a head having a plurality of nozzles for discharging an ink containing thermoplastic resin particles and having a viscosity at 50° C. of 2.1 mPa·s or more to a non-ink-absorbing medium and a drive element provided in each of the nozzles, and (2) the method includes driving the drive elements by applying a drive waveform to discharge ink droplets to the medium, which is heated, from the nozzles corresponding to the drive elements, (3) in which a first ink droplet is discharged from the nozzle by the application of the drive waveform to the drive element, and the discharge speed of an ink droplet whose discharge speed is lower of a second ink droplet and a third ink droplet discharged accompanying the first ink droplet is set to 4.0 m/s or more.

According to such a printing method, the generation of ink mist can be suppressed, so that the ink adhesion amount to the nozzle opening surface of the head can be reduced.

Printing System

Embodiments are described taking a printing system in which the “printing apparatus” is used as an ink jet printer (hereinafter referred to as a printer), and the printer and a computer are connected to each other as an example.

A printer 1 of this embodiment prints an image on a non-ink-absorbing medium. The non-ink-absorbing medium is a medium not having an ink absorbing layer. As the non-ink-absorbing medium, a plastic film which is not surface-treated for ink jet printing, one in which a base material, such as paper, is plastic-coated or plastic film is pasted to the base material, and the like are mentioned, for example. As the plastic as used herein, polyvinyl chloride, polyethylene terephthalate, polycarbonate, polystyrene, polyurethane, polyethylene, polypropylene, and the like are mentioned.

The printer 1 of this embodiment employs an ink containing thermoplastic resin particles (hereinafter also referred to as a resin ink) and having a viscosity at 50° C. of 2.1 mPa·s or more. As such an ink, one disclosed in JP-A-2010-221670 is mentioned, for example. When the resin ink dries, the resin ink forms a firm resin film in such a manner as to cover a colorant on the medium. Therefore, when printing an image on the non-ink-absorbing medium, scratch resistance can be given to the image by the use of the resin ink. Examples of such an ink are mentioned below.

The ink to be used in this embodiment does not substantially contain glycerin whose boiling point under one atmospheric pressure is 290° C. When the ink substantially contains glycerin, the drying properties of the ink sharply decrease. As a result, on various target recording media, particularly non-ink-absorbing or low-ink-absorbing target recording media, not only density unevenness of an image is noticeable and but the fixability of the ink cannot be obtained. Furthermore, it is preferable not to substantially contain alkylpolyols (except for the glycerin) whose boiling point at a pressure equivalent to one atmospheric pressure is 280° C. or higher.

Herein, the description “not substantially contain” in this specification means not compounding the same with an amount exceeding the amount at which the significance of adding the same is sufficiently demonstrated. When quantitatively described, it is preferable not to contain the glycerin in a proportion of 1.0% by mass or more based on the total mass (100% by mass) of the ink, more preferably 0.5% by mass or more, still more preferably 0.1% by mass or more, yet still more preferably 0.05% by mass or more, particularly preferably 0.01% by mass or more, and the most preferably 0.001% by mass or more.

Hereinafter, additives (components) which are contained or can be contained in the ink of this embodiment are described.

The ink of this embodiment may also contain a coloring material. The coloring material is selected from pigments and dyes.

In this embodiment, the light fastness of the ink can be increased by using pigments as the coloring material. As the pigments, both inorganic pigments and organic pigments can be used.

The inorganic pigments are not particularly limited, and, for example, carbon black, iron oxide, titanium oxide, and silica oxide are mentioned.

The organic pigments are not particularly limited and, for example, quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments are mentioned. As examples of the organic pigments, the following pigments are mentioned.

Mentioned as the pigments for use in cyan ink are C.I. pigment blue 1, 2, 3, 15, 15:1, 15:2, 15:3, 15:4, 15:6, 15:34, 16, 18, 22, 60, 65, and 66, and vat blue 4 and 60. Among the above, at least either one of the C.I. pigment blue 15:3 and 15:4 is preferable.

Mentioned as pigments for use in magenta ink are C.I. pigment red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57: 1, 88, 112, 114, 122, 123, 144, 146, 149, 150, 166, 168, 170, 171, 175, 176, 177, 178, 179, 184, 185, 187, 202, 209, 219, 224, 245, 254, and 264, and C.I. pigment violet 19, 23, 32, 33, 36, 38, 43, and 50. Among the above, one or more kinds selected from the group consisting of the C.I. pigment red 122, the C.I. pigment red 202, and the C.I. pigment violet 19 are preferable.

Mentioned as pigments for use in yellow ink are C.I. pigment yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, 180, 185, and 213. Among the above, one or more kinds selected from the group consisting of the C.I. pigment yellow 74, 155, and 213 are preferable.

As pigments for use in ink of colors other than the colors above, such as green ink and orange ink, known pigments are mentioned.

The average particle size of the pigments is preferably is 250 nm or lower because the clogging in the nozzles can be suppressed and the discharge stability becomes further excellent. The average particle size in this specification is based on the volume. As a measuring method, the average particle size can be measured by a particle size distribution meter employing a laser diffraction scattering method as a measurement principle, for example. As the particle size distribution meter, a particle size distribution meter employing a dynamic light scattering method as a measurement principle (e.g., Microtrack UPA manufactured by Nikkiso Co., Ltd.) is mentioned, for example.

In this embodiment, dyes can be used as the coloring material. As the dyes, acid dyes, direct dyes, reactive dyes, and basic dyes can be used without particular limitation.

The content of the coloring material is preferably 0.4% by weight or more and 12% by mass or lower and more preferably 2% by mass or more and 5% by mass or lower based on the total mass (100% by mass) of the ink.

The ink in this embodiment contains resin. Due to the fact that the ink contains resin, a resin coating film is formed on a target recording medium, and, as a result, an effect of sufficiently fixing the ink onto the recording medium to mainly make the image scratch resistance excellent is demonstrated. Therefore, a resin emulsion is preferably a thermoplastic resin.

The thermal deformation temperature of the resin is preferably 40° C. or higher because advantageous effects such that it is hard to cause the clogging of the head and scratch resistance is imparted to recorded matter are obtained. More preferably, the thermal deformation temperature is 60° C. or higher.

Herein, the “thermal deformation temperature” in this specification is a temperature value indicated by a glass transition temperature (Tg) or a Minimum Film forming Temperature (MFT). More specifically, the description that “the thermal deformation temperature is 40° C. or higher” means that either Tg or MFT may be 40° C. or higher. Since the superiority or inferiority of the redispersibility of resin is more easily understood by the MFT than by the Tg, the thermal deformation temperature is preferably a temperature value indicated by the MFT. In the case of an ink excellent in the redispersibility of resin, the ink does not stick, and therefore the clogging of a head 31 is difficult to occur.

The Tg in this specification is indicated by a value measured by a differential scanning calorimetry method. The MFT in this specification is indicated by a value measured by ISO 2115:1996 (Title: Plastics-Polymer dispersions-Determination of white point temperature and minimum film-forming temperature).

Specific examples of the thermoplastic resin are not particularly limited and includes (meth)acrylic polymers, such as poly(meth)acrylic ester or copolymers thereof, polyacrylonitrile or copolymers thereof, polycyanoacrylate, polyacrylamide, and poly(meth)acrylic acid, polyolefin polymers, such as polyethylene, polypropylene, polybutene, polyisobutylene, polystyrene and copolymers thereof, petroleum resin, coumarone-indene resin, and terpene resin, polyvinyl acetate or copolymers thereof, vinyl acetate or vinyl alcohol polymers, such as polyvinyl alcohol, polyvinyl acetal, and polyvinyl ether, halogen containing polymers, such as polyvinyl chloride or copolymers thereof, polyvinylidene chloride, fluororesin, and fluororubber, nitrogen containing vinyl polymers, such as polyvinyl carbazole, polyvinyl pyrrolidone or copolymers thereof, polyvinyl pyridine, and polyvinyl imidazole, diene polymers, such as polybutadiene or copolymers thereof, polychloroprene, and polyisoprene (butyl rubber), and other ring opening polymerization resin, condensation polymerization resin, and natural polymer resin.

The content of the resin is preferably 1% by mass to 30% by mass and more preferably 1% by mass to 5% by mass based on the total mass (100% by mass) of the ink. When the content is within the range mentioned above, glossiness and scratch resistance of images to be formed can be made excellent.

As the resin which may be compounded in the ink, a resin dispersant, a resin emulsion, wax, and the like are mentioned, for example.

The ink of this embodiment may also contain a resin emulsion. The resin emulsion demonstrates an effect of achieving excellent image scratch resistance by forming a resin coating film preferably with wax (emulsion) when a target recording medium is heated to thereby sufficiently fix the ink onto the target recording medium. Due to the above-described effect, recorded matter on which recording is performed using an ink containing the resin emulsion achieves excellent scratch resistance particularly on non-ink-absorbing or low-ink-absorbing recording media.

The resin emulsion functioning as a binder is contained in the ink in an emulsion state. By compounding the resin functioning as a binder in the ink in an emulsion state, the viscosity of the ink is easily adjusted in a proper range in an ink jet recording method and storage stability and discharge stability of the ink are made more excellent.

The resin emulsion includes, but not limited to the following examples, homopolymers or copolymers of (meth)acrylic acid, (meth)acrylic acid ester, acrylonitrile, cyanoacrylate, acryl amide, olefin, styrene, vinyl acetate, vinyl chloride, vinyl alcohol, vinyl ether, vinyl pyrrolidone, vinyl pyridine, vinyl carbazole, vinyl imidazole, and vinylidene chloride, fluororesin, and natural resin, for example. Among the above, at least either one of (meth)acrylic resin and styrene-(meth)acrylic acid copolymer resin is preferable, at least either one of acrylic resin and styrene-acrylic acid copolymer resin is more preferable, and styrene-acrylic acid copolymer resin is still more preferable. The copolymers may have any form of a random copolymer, a block copolymer, an alternating copolymer, and a graft copolymer.

The average particle size of the resin emulsion is preferably in the range of 5 nm to 400 nm and more preferably in the range of 20 nm to 300 nm in order to make storage stability and discharge stability of the ink more excellent.

The content of the resin emulsion in the resin is preferably in the range of 0.5 to 7% by mass based on the total mass (100% by mass) of the ink. When the content is within the range mentioned above, the solid content concentration can be lowered, so that the discharge stability can be made more excellent.

The ink of this embodiment may also contain wax. Due to the fact that the ink contains wax, the fixability of the ink becomes more excellent on non-ink-absorbing and low-ink-absorbing target recording media. Among various kinds of wax, an emulsion type wax is more preferable. The wax includes, but not limited to the following wax, polyethylene wax, paraffin wax, and polyolefin wax, for example. Among the above, the polyethylene wax described later is preferable.

The “wax” in this specification means one in which solid wax particles are dispersed in water using a surfactant described later.

Due to the fact that the ink contains polyethylene wax, the scratch resistance of the ink can be made excellent.

The average particle size of the polyethylene wax is preferably in the range of 5 nm to 400 nm and more preferably in the range of 50 nm to 200 nm in order to make the storage stability and the discharge stability of the ink more excellent.

The content (in terms of solid content) of the polyethylene wax is mutually independently, preferably in the range of 0.1 to 3% by mass, more preferably in the range of 0.3 to 3% by mass, and still more preferably in the range of 0.3 to 1.5% by mass based on the total mass (100% by mass) of the ink. When the content is within the range mentioned above, the ink can be favorably solidified and fixed also on non-ink-absorbing or low-ink-absorbing recording media and the storage stability and the discharge stability of the ink are made more excellent.

The ink of this embodiment may also contain a surfactant. The surfactant includes, but not limited to the following substances, nonionic surfactants, for example. The nonionic surfactants have action of uniformly spreading the ink on a target recording medium. Therefore, when ink jet recording is performed using an ink containing the nonionic surfactant, a high definition image which is hardly blurred is obtained. Such a nonionic surfactant includes, but not limited to the following substances, a silicon surfactant, a polyoxy ethylene alkyl ether surfactant, a polyoxypropylene alkyl ether surfactant, a polycyclic phenyl ether surfactant, a sorbitan derivative, and a fluorine surfactant, for example. Among the above, the silicon surfactant is preferable.

The content of the surfactant is preferably in the range of 0.1% by mass or more and 3% by mass or lower based on the total mass (100% by mass) of the ink because the storage stability and the discharge stability of the ink become more excellent.

The ink of this embodiment may contain water. In particular, when the ink is a water-based ink, water is a main medium of the ink. When a target recording medium is heated in ink jet recording, water is a component which evaporates and disperses.

The ink of this embodiment may also contain known volatile water-soluble organic solvents. As described above, however, it is preferable for the ink of this embodiment not to substantially contain glycerin (Boiling point under one atmospheric pressure of 290° C.) which is one kind of the organic solvent and not to substantially contain alkylpolyols (except for the glycerin) whose boiling point under a pressure equivalent to one atmospheric pressure is 280° C. or higher.

The ink of this embodiment may further contain an antiseptic/antifungal agent, an antirust, a chelating agent, and the like, in addition to the components.

It is preferable for the ink composite of this embodiment to contain an aprotic polar solvent. Due to the fact that the ink composition contains the aprotic polar solvent, the resin particles described above contained in the ink are dissolved, so that the clogging of the nozzles can be effectively prevented in ink jet recording. Moreover, the aprotic polar solvent has a property of dissolving a recording medium, such as vinyl chloride, and the adhesiveness of an image improves.

The aprotic polar solvent is not particularly limited and preferably includes one or more aprotic polar solvent selected from pyrolidones, lactones, sulfoxides, imidazolidinones, sulfolanes, urea derivatives, dialkyl amides, cyclic ethers, and amide ethers. Typical examples of the pyrolidones include 2-pyrolidone, N-methyl-2-pyrolidone, and N-ethyl-2-pyrolidone. Typical examples of the lactone include γ-butyrolactone, γ-valerolactone, and ε-caprolactone. Typical examples of the sulfoxides include dimethylsulfoxide and tetra-methylene sulfoxide. Typical examples of the imidazolidinones include 1,3-dimethyl-2-imidazolidinone. Typical examples of the sulfolanes include sulfolane and dimethyl sulfolane. Typical examples of the urea derivatives include dimethyl urea and 1,1,3,3-tetramethylurea. Typical examples of the dialkylamides include dimethylformamide and dimethylacetamide. Typical examples of the cyclic ether include 1,4-dioxane and tetrahydrofuran. Among the above, the pyrolidones, the lactones, the sulfoxides, and the amide ethers are particularly preferable from the viewpoint of the above-described effects. 2-pyrolidone is the most preferable.

The content of the aprotic polar solvent is preferably in the range of 3 to 30% by mass and more preferably in the range of 8 to 20% by mass based on the total mass (100% by mass) of the ink.

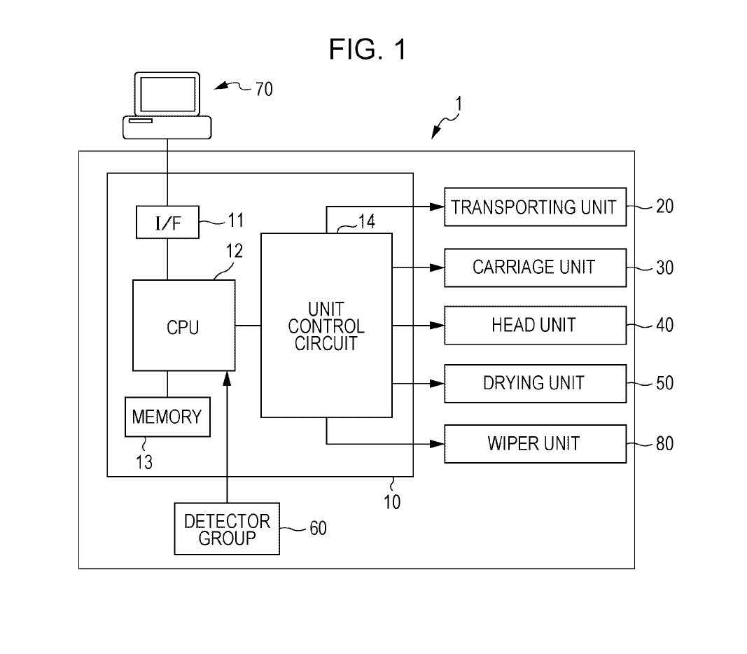

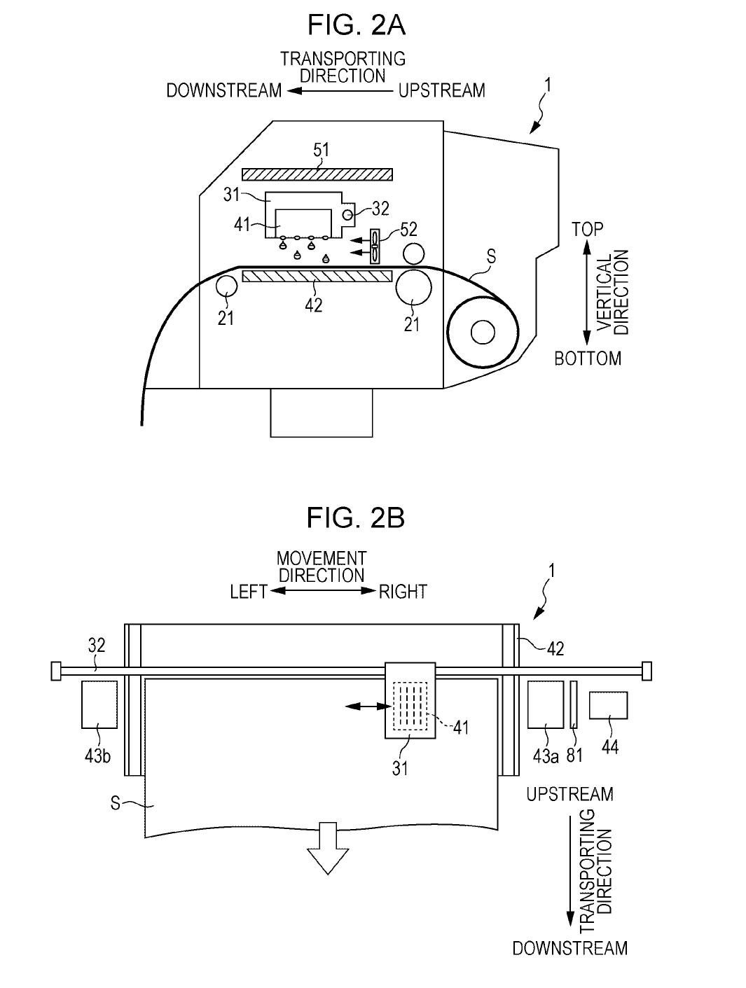

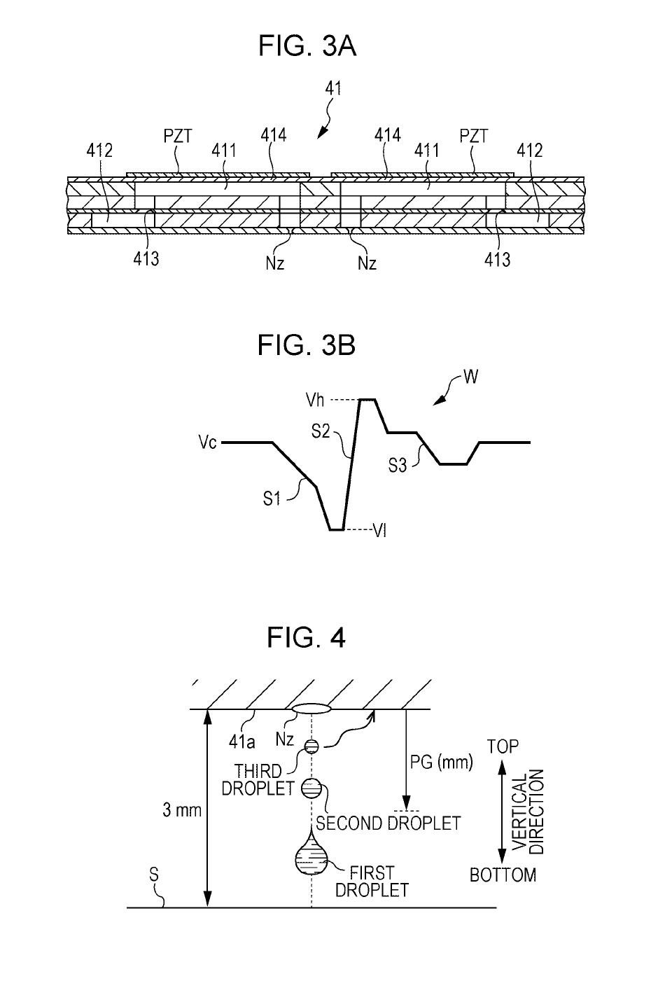

FIG. 1 is a block diagram illustrating the entire configuration of a printing system. FIG. 2A is a schematic cross sectional view of the printer 1 as viewed from the movement direction of a head 41. FIG. 2B is a schematic upper surface view of the printer 1. FIG. 3A is a schematic cross sectional view illustrating the structure of the head (one part). FIG. 3B is a view illustrating a drive waveform W for discharging ink droplets from nozzles Nz. The printer 1 has a controller 10, a transporting unit 20, a carriage unit 30, a head unit 40, a drying unit 50, a wiper unit 80, and a detector group 60. The printer 1 is communicatively connected to a computer 70. By a printer driver installed in the computer 70, print data for making the printer 1 print an image is created, and then the print data is transmitted to the printer 1.

The controller 10 in the printer 1 performs overall control in the printer 1. An interface portion 11 transmits and receives data between the printer 1 and the computer 70 which is an external apparatus. A CPU 12 is an arithmetic processing unit for performing overall control of the printer 1, and controls each unit through a unit control circuit 14. A memory 13 secures a space for storing the program of the CPU 12, a working space, and the like. The detector group 60 monitors the state in the printer 1 and then outputs the detection results to the controller 10.

The transporting unit 20 sets a medium S (non-ink-absorbing medium) which is an image printing target to a position, at which printing can be performed, by transporting rollers 21, and transports the medium S to the downstream side in the transporting direction. In FIG. 2A, a continuous medium rolled in the shape of a roll is illustrated but a medium cut into a predetermined size may be used.

The carriage unit 30 moves the head 41 carried on a carriage 31 along a guide rail 32 in a movement direction which is a direction crossing (generally a direction orthogonal to) the transporting direction of the medium S.

The head unit 40 has the head 41 which discharges an ink to the medium S, a platen 42 which supports the medium S from the back surface, ink receiving portions 43a and 43b, and a cap 44. As illustrated in FIG. 3A, the head 41 has a plurality of nozzles Nz which discharge an ink, a plurality of pressure chambers 411 provided for each of the nozzles Nz, a common ink chamber 412 provided for each ink color an ink supply path 413 which connects each pressure chamber 411 and each common ink chamber 412, and a plurality of piezoelectric elements PZT (equivalent to a drive element) provided for each nozzle Nz. The common ink chamber 412 communicates the plurality of pressure chambers 411 through the ink supply path 413. Each pressure chamber 411 communicates one corresponding nozzle Nz. An ink stored in the ink cartridge is supplied to the common ink chamber 412, moves to the pressure chamber 411, and then discharged from the nozzle Nz.

On the head 41, opening portions of the nozzles Nz are formed and an nozzle opening surface is formed in which a nozzle row in which the nozzle openings are lined is formed for each color of the ink to be discharged. For example, a black nozzle row which discharges a black ink, a cyan nozzle row which discharges a cyan ink, a magenta nozzle row which discharges a magenta ink, a yellow nozzle row which discharges a yellow ink, and the like are constituted.

The piezoelectric element PZT is joined to an elastic board 414 constituting the pressure chamber 411 corresponding to the piezoelectric element PZT. By applying the drive waveform W illustrated in FIG. 3B to the piezoelectric element PZT by the controller 10 (equivalent to the control portion), ink droplets are discharged from the nozzle Nz corresponding to the piezoelectric element PZT.

When specifically described, the drive waveform W has a first element S1 which lowers the potential from a midpoint potential Vc to a lowest potential Vl which is relatively lower than the midpoint potential Vc, a second element S2 which increases the potential from the lowest potential Vl to a highest potential Vh which is relatively higher than the lowest potential Vl, and a third element S3 which returns the potential to the midpoint potential Vc which is relatively lower than the highest potential Vh from the highest potential Vh. By the application of the first element S1 to the piezoelectric element PZT, distortion to the pressure chamber side of the piezoelectric element PZT becomes small, so that the pressure chamber 411 expands in connection with the distortion. Thereafter, by the application of the second element S2 to the piezoelectric element PZT, distortion to the pressure chamber side of the piezoelectric element PZT becomes large, and then the pressure chamber 411 contracts, so that ink droplets are discharged from the nozzles Nz. Finally, when the third element S3 is applied to the piezoelectric element PZT, the distortion amount of the piezoelectric element PZT and the capacity of the pressure chamber 411 return to the original distortion amount and the original capacity, respectively.

The ink receiving portions 43a and 43b and the cap are disposed in a non-printing region in the movement direction of the head 41 (i.e., a region where the medium S does not pass) and are disposed at a position where the ink receiving portions 43a and 43b and the cap 4 can face the nozzle opening surface of the head 41 moving in the movement direction by the carriage 31. The ink receiving portions 43a and 43b receive ink discharged from the nozzles Nz in flushing treatment. When cleaning, the cap 44 is closely attached to the nozzle opening surface of the head 41 to suck the ink from the nozzles Nz by a pump and, when the printing stops, the cap 44 is closely attached to the nozzle opening surface of the head 41 to suppress the evaporation of the ink solvent from the nozzles Nz, for example.

The drying unit 50 dries the ink impacting on the medium S, and has a heater 51 (e.g., infrared heater) and a fan 52. As illustrated in FIG. 2A, the heater 51 (equivalent to the heating portion) is disposed at an upper position relative to the carriage 31 and the head 41 and at a position facing the platen 42 and heats the entire region of the medium S supported by the platen 42. The fan 52 delivers wind between the nozzle opening surface of the head 41 and the medium S.

As described above, the printer 1 of this embodiment prints an image by discharging a resin ink on a non-ink-absorbing medium S. The resin ink impacting on the non-ink-absorbing medium S is likely to flow on the medium S. Therefore, unless the resin ink is dried in such a manner that the resin ink is fixed at the impacting position, a desired image cannot be printed. Then, by heating the medium S by the heater 51 and delivering wind to the resin ink on the medium S by the fan 52, the quick-drying property of the resin ink impacting on the medium S can be increased, so that the flow of the resin ink on the medium S can be suppressed.

The uneven heating of the heater 51 can be suppressed by the wind delivered by the fan 52. It is preferable that the surface temperature of the medium S is 45° C. or higher and 60° C. or lower. In order to prevent excessive heating of the head 41 by the heat of the heater 51, a thermal insulating material and a heat dissipating material may be provided at a portion other than the nozzle opening surface of the carriage 31. In this embodiment, the medium S is heated from the upper portion relative to the head 41. The invention is not limited to the configuration, and, a heater may be provided in the platen 42, and the medium S may be heated from a lower portion. The medium S before printing may be heated at the upstream side relative to the platen 42 in the transporting direction or the medium S after printing may be heated at the downstream side in the transporting direction relative to the platen 42. The fan 52 may not be provided.

In the printer 1 of such a configuration, the controller 10 alternately repeats the discharge operation of discharging ink droplets from the nozzles Nz while moving the head 41 in the movement direction by the carriage 31 and the transporting operation of transporting the medium S to the downstream side in the transporting direction by the transporting unit 20. As a result, since dots are formed by the later discharge operation at positions different from positions of dots formed by the previous discharge operation, a two-dimensional image is printed on the medium S. In the following description, the operation in which the head 41 moves once in the movement direction is also referred to as a “pass”.

Problems and Solution Means of Ink Mist

FIG. 4 is a view illustrating the ink droplets discharged from the opening portion of the nozzle Nz provided in a nozzle opening surface 41a of the head 41. When the drive waveform W (FIG. 3B) is applied to the piezoelectric element PZT (FIG. 3A), the meniscus (Free surface of the ink exposed from the nozzle opening) of the ink extends in a columnar shape from the nozzle Nz, and then the ink column is divided near the nozzle Nz, so that ink droplets are discharged. The ink droplet is divided into a main droplet at the tip portion and a minute droplet at a back end portion during flight or, after the ink column is divided, a minute droplet is discharged by the vibration of the meniscus in some cases. More specifically, when the drive waveform W is applied to the piezoelectric element PZT, a plurality of minute ink droplets are generated accompanying the main ink droplet with the main droplet. The plurality of minute ink droplets generated accompanying the main droplet refer to ink droplets which are unintentionally generated when discharging the main droplet, and the drive waveform is not applied in order to generate the minute ink droplets.

In this specification, among the plurality of ink droplets discharged from the nozzle Nz by the application of the drive waveform W to the piezoelectric element PZT, the main ink droplet located at the closest portion to the medium S (lower side) during flight is referred to as a “first ink droplet” or a “first droplet”, a minute ink droplet discharged accompanying the first ink droplet and located at the second closest portion to the medium S side next to the first droplet during flight is referred to as a “second ink droplet” or a “second droplet”, and a minute ink droplet discharged accompanying the first ink droplet and located at the third closest portion to the medium S side next to the second droplet during flight is referred to as a “third ink droplet” or a “third droplet”.

In the second and third minute ink droplets, the ink weight is smaller and the discharge speed is lower than those of the first main ink droplet. Therefore, the second and third minute ink droplets are affected by the air resistance to easily lose the speed to the medium S during flight. The second and third ink droplets which lose the speed do not impact on the medium S and rise up in the form of mist to adhere to the nozzle opening surface 41a of the head 41 in some cases.

As described above, since the resin ink is discharged to a non-ink-absorbing medium S in the printer 1 of this embodiment, it is necessary to dry the resin ink impacting on the medium S to suppress the flow of the resin ink on the medium S. Therefore, the printer 1 is provided with the heater 51 of a high temperature for heating the medium S therein. Thus, under the influence of the heat from the heater 51 and the radiant heat from the medium S, the environmental temperature in the printer 1 increases (e.g., reaches 40° C.), so that the ink temperature in the head 41 also increases (e.g., reaches 50° C.). In the ink, the viscosity decreases as an increase in the temperature. When the viscosity of the ink excessively decreases (e.g., when the ink viscosity at 50° C. is 1.7 mPa·s or lower), the meniscus extending in a columnar shape from the nozzle Nz becomes long (trailing long), so that minute ink droplets are likely to be generated.

In the printer 1 of this embodiment, the nozzle opening surface 41a of the head 41 is heated under the influence of the heat from the heater 51 of a high temperature and the radiant heat from the medium S. For example, when the surface temperature of the medium S is set to 45° C. to 60° C., the temperature of the nozzle opening surface 41a increases to 40° C. to 55° C.

Therefore, in the printer 1 of this embodiment, when ink mist adheres to the nozzle opening surface 41a, the adhering ink dries on the nozzle opening surface 41a of a high temperature to stick to the nozzle opening surface 41a. In the printer 1 of this embodiment, a resin ink is used in order to increase the scratch resistance of an image to be printed on a non-ink-absorbing medium. Therefore, the ink adhering to the nozzle opening surface 41a and drying forms a resin film, so that the ink becomes difficult to separate from the nozzle opening surface 41a. In addition, when an ink in which the amount of a lubricant, for example, is reduced in order to increase the quick-drying property of the ink is used, the ink is more likely to dry on the nozzle opening surface 41a to stick to the nozzle opening surface 41a.

As a result, the ink sticks to the nozzle opening surface 41a of the head 41, so that the opening portions of the nozzles Nz are inhibited with the sticking ink, which results in the fact that the discharge of the ink droplets from the nozzles Nz is inhibited. For example, discharge defects occur, such that a determined amount of the ink is not discharged from the nozzles Nz, the flight direction of the ink droplets discharged from the nozzles Nz deviates, and, in the worst case, the nozzles Nz are completely inhibited by the sticking ink, so that the ink cannot be discharged, and thus the image quality of the printed image deteriorates. Moreover, the ink sticking onto the nozzle opening surface 41a as described above cannot be eliminated by usual flushing treatment or ink suction. Therefore, by the printer 1 and the printing method of this embodiment, the invention aims at reducing the adhesion amount of the ink to the nozzle opening surface 41a of the head 41.

Then, the printer 1 of this embodiment has a feature of using a resin ink having a viscosity at 50° C. of 2.1 mPa·s or more as described above. Thus, by the use of a resin ink in which the viscosity at a high temperature (50° C.) is higher than a common resin ink, even when the environmental temperature in the printer 1 increases due to the heat of the heater 51, so that the ink temperature in the head 41 increases, the length (tailing of the ink) of the meniscus extending in a columnar shape from the nozzle Nz can be suppressed. Therefore, the generation of minute ink droplets is suppressed, so that the ink adhesion amount to the nozzle opening surface 41a of the head 41 can be reduced.

Furthermore, in the printer 1 of this embodiment, in order to suppress the generation of the minute ink droplets, the discharge speed of ink droplets is set to a predetermined speed. Hereinafter, the discharge speed of the ink droplets in the printer 1 of this embodiment is described in detail.

Discharge Speed of Ink Droplets

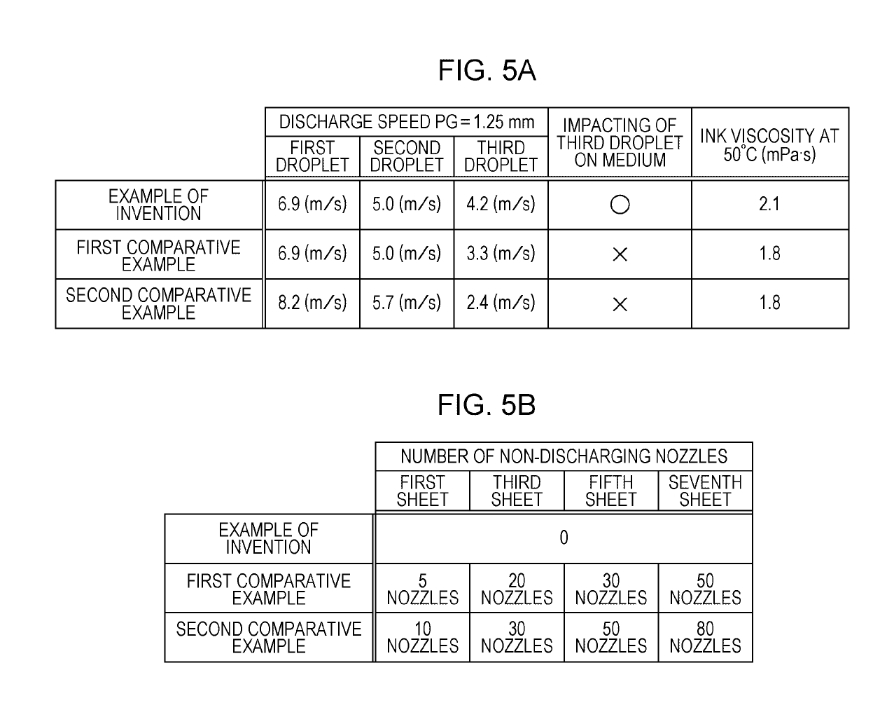

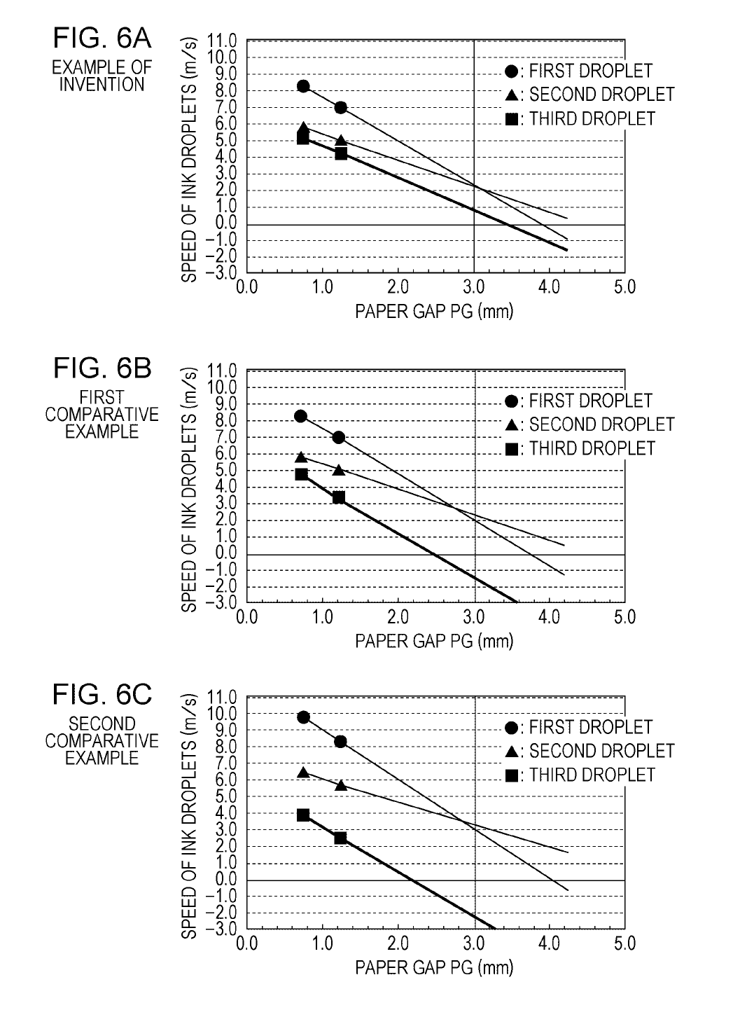

FIG. 5A is a table showing a difference in the discharge speed of the ink droplets and the results of evaluating the formation of mist of the third ink droplet in Example of the invention and Comparative Examples. FIG. 5B is a table showing the generation number of non-discharging nozzles in Example of the invention and Comparative Examples. FIG. 6A to FIG. 6C are graphs showing a difference in the speed of the first to third droplets in Example of the Invention and Comparative Examples. For the following description, as illustrated in FIG. 4, the position of the nozzle opening surface (undersurface in this embodiment) 41a of the head 41 is defined as a reference position and the distance from the nozzle opening surface 41a to a certain lower point is referred to as a paper gap (PG). For example, a 1 mm lower point from the nozzle opening surface 41a is referred to as a 1 mm paper gap point. In the printer 1 of this embodiment, the distance from the nozzle opening surface 41a of the head 41 to the medium S is 3 mm.

Then, under the conditions shown below (Example of the invention, First Comparative Example, Second Comparative Example), ink droplets are discharged from the nozzles Nz of the printer 1 of this embodiment, and the speed of the ink droplets was measured (FIG. 5A and FIG. 6A to FIG. 6C). The speed of the first droplet to the third droplet moving to the medium S (lower portion) was measured at a 0.75 mm paper gap point and a 1.25 mm paper gap point using the apparatus which visualizes the ink droplets.

Moreover, ink droplets are continuously discharged to a plurality of A1 size paper sheets S from 360 nozzles Nz under the conditions shown below, and then the generation number of non-discharging nozzles in which ink droplets are not discharged from the nozzles Nz was acquired (FIG. 5B).

Each graph shown in each of FIG. 6A to FIG. 6C shows an approximation straight line based on the speed of each ink droplet at the 0.75 mm paper gap point and the 1.25 mm paper gap point. The horizontal axis represents a paper gap PG (mm) and the vertical axis represents the speed (m/s) of the ink droplets moving to the medium S (lower portion).

More specifically, each graph shows the speed (m/s) of the ink droplets at points located below the nozzle opening surface 41a by the distance of the paper gap PG. In each graph, the speed results of the first droplets are represented by a thin line and a circle (), the speed results of the second droplets are represented by a thin line and a triangle (▴), and the speed results of the third droplets are represented by a thick line and a square (▪).

The table of FIG. 5A shows the evaluation results of the impacting of the third ink droplets on a medium. At a 3 mm paper gap point, when the speed of the third ink droplet moving downward is more than 0 m/s, the impacting of the third ink on a medium is evaluated as “◯ (success)”. When the speed of the third ink droplet moving downward is 0 m/s or lower, the impacting of the third ink droplet on a medium is evaluated as “x (failure)”.

In Example of the invention, an ink containing thermoplastic resin particles and having a viscosity at 50° C. of 2.1 mPa·s was used as described above, and ink droplets were discharged from the nozzles Nz by applying the drive waveform W illustrated in FIG. 3B to the piezoelectric elements PZT.

In First Comparative Example, an ink containing thermoplastic resin particles and having a viscosity at 50° C. of 1.8 mPa·s, which is lower than the viscosity of Example of the invention, was used, and ink droplets were discharged from the nozzles Nz by applying the drive waveform W illustrated in FIG. 3B to the piezoelectric elements PZT.

In Second Comparative Example, an ink containing thermoplastic resin particles and having a viscosity at 50° C. of 1.8 mPa·s was used similarly as in the first Comparative Example. In Second Comparative Example, the ink droplets were discharged from the nozzles Nz by applying the drive waveform W in which the potential difference between the highest potential Vh and the lowest potential Vl is larger in the drive waveform W than that of the drive waveform W used in First Comparative Example to the piezoelectric elements PZT.

As a result, in Example of the invention, as shown in FIG. 5A and FIG. 6A, the results such that the speed of the first droplet (main ink droplet) at the 1.25 mm paper gap point was 6.9 m/s, the speed of the second ink droplet was 5.0 m/s, and the speed of the third ink droplet was 4.2 m/s were obtained. On the other hand, in First Comparative Example, the results such that the speed of the first droplet at the 1.25 mm paper gap point was 6.9 m/s, the speed of the second ink droplet was 5.0 m/s, and the speed of the third ink droplet was 3.3 m/s were obtained as shown in FIG. 5A and FIG. 6B. More specifically, the result such that the speed of the third ink droplet in Example of the invention was higher than that of First Comparative Example was obtained. Although the reason therefor is not certain, it is considered in Example of the invention that the change in the behavior of the meniscus of the nozzles Nz when discharging the ink caused by increasing the ink viscosity at 50° C. as compared with that of First Comparative Example has an effect thereon.

In Second Comparative Example, the results such that the speed of the first droplet at the 1.25 mm paper gap point was 8.2 m/s, the speed of the second ink droplet was 5.7 m/s, and the speed of the third ink droplet was 2.4 m/s were obtained as shown in FIG. 5A and FIG. 6C. More specifically, the result such that the speed of the first ink droplet in Second Comparative Example was higher than that of First Comparative Example was obtained. This is considered to be because the potential difference between the lowest potential Vl and the highest potential Vh of the drive waveform W was made higher in Second Comparative Example than in First Comparative Example, and therefore a high pressure was applied to the ink in the pressure chamber 411, so that the ink droplets were discharged from the nozzles Nz.

In Example of the invention, the results such that the speed of all the ink droplets (the first droplet to the third droplet) moving downward at the 1.25 mm paper gap point was 4.0 m/s or more and all the ink droplets had a speed moving downward at the 3 mm paper gap point (at the point where the medium S is located) were obtained as shown in the graph of FIG. 6A. More specifically, the result such that the speed of all the ink droplets was more than 0 m/s until the ink droplets impacted on the medium S was obtained. Therefore, according to Example of the invention, all the ink droplets of the first droplet to the third droplet impacted on the medium S without rising up in the form of mist, and therefore the amount of the ink adhering to the nozzle opening surface 41a can be reduced. As a result, the ink does not deposit on the nozzle opening surface, so that the inhibition of the discharge of the ink droplets from the nozzles Nz due to the deposited ink can be prevented. This can be said from the results such that, as shown in FIG. 5B, even when the ink droplets are continuously discharged from the nozzles Nz to seven A1 size paper sheets S, the ink is normally discharged from all the 360 nozzles Nz and the generation number of non-discharging nozzles is zero in Example of the invention.

On the other hand, in First Comparative Example, the results such that the speed of the first droplet to the second droplet moving downward at the 1.25 mm of paper gap point was 4.0 m/s or more but the speed of the third ink droplet moving downward was lower than 4.0 m/s, and the first droplet to the second droplet had the speed of moving downward at the 3 mm paper gap point (point where the medium S is located) but the third droplet did not have the speed of moving downward were obtained as shown in the graph of FIG. 6B. Specifically, there is a possibility such that the speed of the third droplet reaches 0 m/s at the 2.5 mm paper gap point, and thus the third droplet rises up in the form of mist at the point to adhere to the nozzle opening surface 41a.

Similarly, also in Second Comparative Example, the results such that the speed of the third droplet moving downward at the 1.25 mm paper gap point was lower than 4.0 m/s and the third droplet did not have the speed of moving downward at the 3 mm paper gap point (point where the medium S is located) were obtained as shown in the graph of FIG. 6C. Specifically, there is a possibility such that the speed of the third droplet reaches 0 m/s at the 2.2 mm paper gap point, and thus the third droplet rises up in the form of mist at the point to adhere to the nozzle opening surface 41a.

More specifically, in First Comparative Example and Second Comparative Example, there is a possibility such that the third droplet cannot be made to impact on the medium S and the third droplet rises up in the form of mist to adhere to the nozzle opening surface 41a to inhibit the discharge of the ink droplets from the nozzles Nz. This can be said also from the result such that when the ink droplets are continuously discharged from the nozzles Nz to the A1 size paper sheets S, 5 nozzles among the 360 nozzles became non-discharging nozzles in First Comparative Example and 10 nozzles among the 360 nozzles became non-discharging nozzles in Second Comparative Example as shown in FIG. 5B. Moreover, as an increase in the number of printing sheets to 3 sheets, sheets, and 7 sheets, the number of non-discharging nozzles increased to 20 nozzles, 30 nozzles, and 50 nozzles in First Comparative Example and the number of non-discharging nozzles increased to 30 nozzles, 50 nozzles, and 80 nozzles in Second Comparative Example. More specifically, the results such that the number of the third ink droplets formed into mist increased as an increase in the number of times of discharging the ink droplets from the nozzles Nz, so that the amount of the ink adhering to the nozzle opening surface 41a increased were obtained.

From the above results, the discharge speed of the second droplet and the third droplet (the second ink droplet and the third ink droplet) discharged from the nozzle Nz by applying the drive waveform W to the piezoelectric element PZT is set to 4.0 m/s or more in the printer 1 of this embodiment. The discharge speed as used herein is the speed of the ink droplets moving to the medium S at a point 1.25 mm away from the nozzle opening surface 41a to the medium S side.

Thus, the minute ink droplets (the second ink droplet and the third ink droplet) generated when discharging ink droplets from the nozzles Nz can be made to impact on the medium S and the minute ink droplets can be prevented from losing the speed during flight to rise up in the form of mist to adhere to the nozzle opening surface 41a. More specifically, the amount of the ink adhering to the nozzle opening surface 41a can be reduced.

Therefore, even in the case where the temperature of the nozzle opening surface 41a becomes high by the heater 51 which heats the medium S, and therefore the ink is likely to stick to the nozzle opening surface 41a and even in the case where the resin ink is used, and therefore the ink adhering to the nozzle opening surface 41a becomes difficult to separate as in the printer 1 of this embodiment, the amount of the ink adhering to the nozzle opening surface 41a is reduced. Thus, the inhibition of the discharge of the ink droplets from the nozzles Nz due to the ink deposited on the nozzle opening surface 41a can be prevented. As a result, the determined amount of the ink can be discharged from the nozzles Nz, the ink droplets can be made to impact on the target position on the medium S, and a degradation of the image quality of the printed image a printing image can be suppressed.

As illustrated in FIG. 5A, the results such that the speed of the first droplet at the 1.25 mm paper gap point is higher than that of First Comparative Example (8.2 m/s>6.9 m/s) but the speed of the third ink droplet was lower than that of First Comparative Example (2.4 m/s<3.3 m/s) were obtained in Second Comparative Example. More specifically, the result such that that when the speed of the first droplet was made excessively high, the speed of the third ink droplet became low was obtained. Although the reason is not certain, it is considered that the potential difference between the lowest potential Vl and the highest potential Vh of the drive waveform W is made larger in Second Comparative Example than in First Comparative Example, and therefore the change in the behavior of the meniscus of the nozzle Nz when discharging the ink has an effect thereon. Therefore, there is a possibility such that when the discharge speed of the first droplet at the 1.25 mm paper gap point is made excessively higher than 6.9 m/s, the discharge speed of the third ink droplet becomes low, so that the third ink droplet loses the speed to rise up in the form of mist to adhere to the nozzle opening surface 41a in some cases also in Example of the invention.

Then, the discharge speed of the first droplet (first ink droplet) discharged from the nozzle Nz by the application of the drive waveform W to the piezoelectric element PZT is set to 7.0 m/s or lower in the printer 1 of this embodiment. The discharge speed as used herein is the speed of the ink droplets moving to the medium S at a point 1.25 mm away from the nozzle opening surface 41a to the medium S side.

Thus, the discharge speed of the third ink droplet becomes low and the formation of mist of the third ink droplet can be suppressed. More specifically, the third ink droplet can be made to impact on the medium S and the amount of the ink adhering to the nozzle opening surface 41a can be reduced.

Printing Method

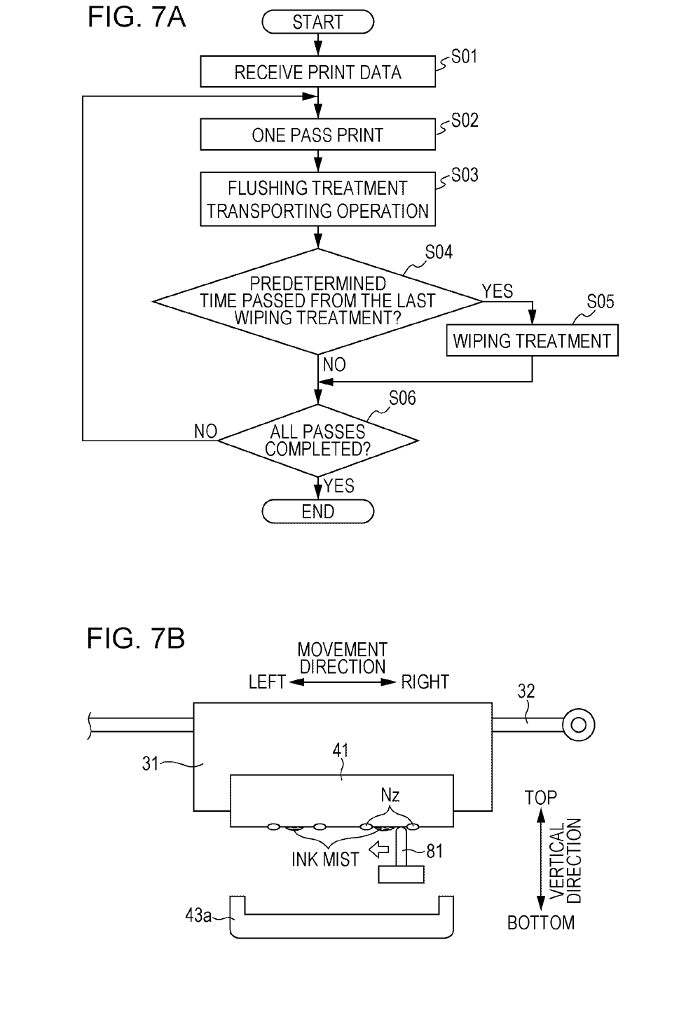

FIG. 7A illustrates a flowchart showing a printing method by the printer 1 of this embodiment. FIG. 7B is a view illustrating wiping treatment. As illustrated in FIG. 1A, the printer 1 of this embodiment has a wiper unit 80. The wiper unit 80 has a wiper member 81 disposed in a non-printing region on the right side in the movement direction as illustrated in FIG. 2B and a movement mechanism (not illustrated) which moves the wiper member 81. As illustrated in FIG. 7B, the wiper member 81 is an approximately plate-shaped member which can abut on the nozzle opening surface 41a of the head 41 and is formed with cloth. The wiper member 81 can move in the movement direction to the nozzle opening surface 41a in a state where the wiper member 81 abuts on the nozzle opening surface 41a of the head 41, and wipes off foreign substances, such as ink mist and dust, adhering to the nozzle opening surface 41a. In FIG. 7B, a detailed description of the movement mechanism which moves the wiper member 81 is omitted. The wiper member 81 is not limited to one formed with cloth and may be one formed with an elastic member, such as rubber, and the like, for example. By forming the wiper member 81 with cloth, the nozzle opening surface 41a can be prevented from being scratched, and since the member change is easy, re-adhesion of the foreign substances which are wiped off can be prevented.

Hereinafter, the flow of a specific printing method by the printer 1 of this embodiment is described.

First, when the controller 10 receives print data from the computer 70 (S01), the controller 10 sets the medium S to a printing starting position by the transporting unit 20, and then causes ink droplets to discharge from the nozzles Nz provided in the head 41 while moving the head 41 sealed with the cap 44 disposed at the home position (herein a non-printing region on the right side in the movement direction) to the left side in the movement direction by the carriage 31 to print an image (one part) on the medium S. More specifically, one pass printing is carried out (S02).

After the one pass printing, the controller 10 makes the ink receiving portion 43b disposed in the non-printing region on the left side in the movement direction and the nozzle opening surface 41a of the head 41 face each other. Then, the controller 10 carries out “flushing treatment” which is cleaning treatment of the head 41 while transporting the medium S to the downstream side in the transporting direction by the transporting unit 20 (S03). The flashing treatment is treatment of forcibly discharging ink droplets from the nozzles Nz provided in the head 41 to the ink receiving portions 43a and 43b. For example, by applying the drive waveform W illustrated in FIG. 3B to the piezoelectric elements PZT more than once, ink droplets are forcibly discharged from the nozzles Nz. As a result, the ink whose viscosity is increased during the one pass printing and the foreign substances entering the nozzles Nz can be discharged from the nozzles Nz, so that clogging of the nozzles Nz can be eliminated. Therefore, the printing of the following pass can be carried out in a state where the nozzles Nz are not clogged.

Next, the controller 10 confirms where a predetermined time passed from the last wiping processing (S04). When a predetermined time progress did not pass from the last wiping processing (S04→NO) and there is the following pass (S06→NO), the controller 10 causes ink droplets to discharge from the nozzles Nz while moving the head 41 to the right side in the movement direction again to print an image (one part) on the medium S (S02), and then carries out the flushing treatment and the transporting operation (S03) again. As described above, since the heater is provided near the head 41 in the printer 1 of this embodiment, the temperature in the printer 1 is high. Therefore, the solvent of the ink is likely to evaporate from the nozzles Nz, so that the nozzles Nz are easily clogged. However, by carrying out the flushing treatment for each pass as in this printing method, the clogging of the nozzles Nz can be suppressed and a degradation of the image quality of the printed image can be suppressed.

On the other hand, when a predetermined time passed from the last wiping treatment (S04→YES), the controller (equivalent to a control portion) moves the head 41 to the non-printing region on the right side in the movement direction, and carries out the wiping treatment (S05). Specifically, as illustrated in FIG. 7B, by moving the wiper member 81 to the left side in the movement direction to the nozzle opening surface 41a in a state where the nozzle opening surface 41a and the wiper member 81 of the head 41 are made abut against each other, the foreign substances (ink mist, dust, and the like) adhering to the nozzle opening surface 41a are wiped off. As illustrated in FIG. 2B, the length of the transporting direction of the wiper member 81 is equivalent to the length of the transporting direction of the head 41. Therefore, by simply moving the wiper member 81 in the movement direction once, the wiper member 81 can wipe the entire region of the nozzle opening surface 41a. Then, the controller 10 repeats a series of the treatment until the printing of all the passes is completed (S06→Yes).

As described above, in the printer 1 of this embodiment, the amount of the ink adhering to the nozzle opening surface 41a is reduced by setting the discharge speed of the second droplet and the third droplet to 4.0 m/s or more. However, it is difficult to completely prevent the adhesion of the ink to the nozzle opening surface 41a. Therefore, the wiping treatment may be periodically carried out as in this printing method. Thus, the ink can be prevented from being deposited on the nozzle opening surface 41a, and thus the inhibition of the discharge of the ink droplets from the nozzles Nz due to the deposited ink can be prevented.

The invention is not limited to carrying out the wiping treatment at each predetermined time, and, for example, the wiping treatment may be carried out for each path. Moreover, although the wiper member 81 is moved in the movement direction to the head 41 in this embodiment, the invention is not limited thereto and the head 41 may be moved to the wiper member 81 or the wiper member 81 may be moved in the transporting direction. Moreover, the wiper member 81 may be provided in the non-printing regions at both sides in the movement direction.

### OTHER EMBODIMENTS

The above-described embodiment is described for facilitating the understanding of the invention, but is not construed as limiting of the invention. The invention can be altered and improved without departing from the gist of the invention and, of course, includes the equivalents of the invention.

Although the wiping treatment is carried out at each predetermined time in the embodiment described above, the wiper member 81 may not be provided in the printer 1, and the wiping treatment may not be carried out.

In the embodiment described above, the printer 1 in which the operation in which ink is discharged while the head 41 is moving in the movement direction and the operation in which the medium S is transported in the transporting direction are repeated is described as an example, but the invention is not limited thereto. For example, a printer may be acceptable in which a head discharges ink to a medium when the medium passes under the fixed head extending over the width/length of the medium S to thereby print a two-dimensional image on the medium. Moreover, for example, a printer may be acceptable in which an operation in which an image is printed while moving the head in the X direction to the medium S transported to a printing region and an operation in which the head is moved in the Y direction are repeated to print an image, and then a portion of the paper S on which an image is not printed yet to the printing region.

Although the method in which ink droplets are discharged from the nozzles Nz by applying the drive waveform to the piezoelectric elements PZT to expand and contract the pressure chamber 411 is mentioned as an example in the embodiment described above, the invention is not limited thereto. For example, a thermal system may be acceptable in which air bubbles are generated in nozzles using heat generating elements, and ink droplets are discharged from the nozzles by the air bubbles.

The entire disclosure of Japanese Patent Application No. 2012-211419 filed on Sep. 25, 2012 is expressly incorporated by reference herein.

What is claimed is:

1. A printing apparatus, comprising:
a head having a plurality of nozzles for discharging an ink containing thermoplastic resin particles and having a viscosity at 50° C. of 2.1 mPa·s or more to a non-ink-absorbing medium and a drive element provided in each of the nozzles;
a heating portion which heats the medium; and
a control portion which drives the drive elements by applying a drive waveform to discharge ink droplets from the nozzles corresponding to the drive elements;
a first ink droplet being discharged from the nozzle by the application of the drive waveform to the drive element, and a discharge speed of an ink droplet whose discharge speed is lower of a second ink droplet and a third ink droplet discharged accompanying the first ink droplet being 4.0 m/s or more.

2. The printing apparatus according to claim 1, wherein the discharge speed of the first ink droplet is 7.0 m/s or lower.

3. The printing apparatus according to claim 1, comprising:
a wiper member which abuts on a nozzle opening surface of the head in which opening portions of the nozzles are provided, wherein
the control portion relatively displaces the nozzle opening surface and the wiper member in a state where the wiper member is made to abut on the nozzle opening surface to thereby wipe off foreign substances adhering to the nozzle opening surface.

4. A printing method, employing (1) a head having a plurality of nozzles for discharging an ink containing thermoplastic resin particles and having a viscosity at 50° C. of 2.1 mPa·s or more to a non-ink-absorbing medium and a drive element provided in each of the nozzles, the printing method comprising:
(2) driving the drive elements by applying a drive waveform to discharge ink droplets to the medium, which is heated, from the nozzles corresponding to the drive elements, (3) a first ink droplet being discharged from the nozzle by the application of the drive waveform to the drive element, and a discharge speed of an ink droplet whose discharge speed is lower of a second ink droplet and a third ink droplet discharged accompanying the first ink droplet being set to 4.0 m/s or more.
